(19) United States
(12) Patent Application Publication
(10) Pub. No.: US 2008/0251134 A1
(43) Pub. Date: Oct. 16, 2008

(54) Fuel cutoff valve

(75) Inventor: Natsushi Miura, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/078,199

(22) Filed: Mar. 27, 2008

(30) Foreign Application Priority Data
Mar. 29, 2007 (JP) 2007-87271

(51) Int. Cl. F16K 31/18

(52) U.S. Cl. 137/409

(57) ABSTRACT

The fuel cutoff valve has a first valve mechanism inside a first valve chamber of a casing. In the first valve mechanism, a seat member installs on the upper part of a first float. The seat member has a seat portion which seats in a first seal part facing a first connection conduit; and a valve support portion projected from the lower face of the seat portion in the direction of up and down movement of the first float. The valve support portion is formed so as to be in contact against the upper end of a bottom support portion of a lower cover when the first float is in the down position. With a simple configuration, the fuel cutoff valve affords reduction of impact noise associated with vibration of the float.

This application claims the benefit of and priority from Japanese Application No. 2007-87271 filed Mar. 29, 2007, the content of which is incorporated herein by reference.

### BACKGROUND OF THE INVENTION

1. Field of the Invention

The present invention relates generally to a fuel cutoff valve for installation in the upper portion of a fuel tank and adapted to permit or cut off communication between the fuel tank and the outside; and relates in particular to a mechanism for reducing impact noise during rising of the float.

2. Description of the Related Art

A fuel cutoff valve is adapted for installation in the tank upper wall of a fuel tank, it will include a casing; a float housed in a valve chamber within the casing; and a spring. The casing is constituted by a cylindrical casing main body closed off at its lower opening by a lower cover. A communication hole is formed in the lower cover, ensuring inflow and outflow of fuel to and from the valve chamber, and ventilation. The float is supported by the spring which rests on the lower cover, and is designed so that a connection conduit connecting to the outside is opened or closed, depending on the fuel level, by a valve portion disposed on the upper part of the float.

The fuel cutoff valve described above had the problem that noise occurs when the float moves up and down repeatedly and knocks against the lower cover, due to vibration produced during driving of the vehicle. Known technologies that address this problem include a technology whereby an elastic impact piece is integrally formed in the lower portion of the float (JU-A 6-40553); and a technology whereby a shock-absorbing member is interposed between the lower face of the float and the lower cover (JU-A 6-40552). However, with the technology taught in JU-A 6-40553, integral formation of an elastic impact piece in the lower portion of a float made of resin has proven difficult in practice. With the technology taught in JU-A 6-40552, the larger number of parts posed a problem.

### SUMMARY

An advantage of some aspects of the invention is to provide a fuel cutoff valve that reduces impact noise in association with vibration of the float with a simple structure.

According to an aspect of the invention is provided with a fuel cutoff valve that is attached to an upper part of a fuel tank, and works by a fuel level in the fuel tank. The fuel cutoff valve comprises: a casing having a casing main body that has a valve chamber communicated with the fuel tank interior and a connection conduit connecting the valve chamber with an outside passage, and a lower cover installed in a lower part of the casing main body and covering a lower opening of the valve chamber; and a float mechanism having a float housed within the valve chamber and moving up and down between an up position and a down position depending on the fuel level, and a rubber seat member installed in an upper part of the float for opening and closing the connection conduit. The seat member has a seat portion for opening and closing the connection conduit, and a valve support element projecting from a lower part of the seat portion in the direction of up and down movement of the float. The valve support element is configured to be supported on the lower cover by being placed on an upper portion of the lower cover at the down position of the float.

In the present invention, depending on the fuel level within the fuel tank, the float moves up and down through inflow of fuel into the valve chamber. The seat member in the upper part of the float will close off the connection conduit by becoming seated against the edge of the opening of the connection conduit. When the float has moved up and down due to the fuel level, the lower end of the valve support element of the seat member will come into contact against the upper end of the bottom support portion of the lower cover. The valve support element is made of rubber, and through contact against the lower end of the bottom support portion will absorb the energy associated with vibration of the float, reducing the noise of impact of the float with the lower cover.

Since the valve support element is made of rubber, its ability to absorb impact energy will be superior in comparison with the resin lower cover. Also, by forming the valve support element as part of the seat member, that is, by constituting the valve support element so as to perform both the function of ensuring a good seal at the edge of the lower opening of the connection conduit by the seat portion, and of projecting downward from the seat portion for installation onto the float, noise reduction can be achieved without any increase in the number of parts.

Also, since the seat member is a separate member from the float, it is possible to select for it a material and shape that are optimal in terms of vibration absorption of the float; and since it attaches easily to floats of fuel cutoff valves of various types it is highly adaptable.

In a preferred embodiment, the present invention provides a fuel cutoff valve adapted to be installed in an upper part of a fuel tank, for permitting or cutting off communication of the fuel tank interior with an outside passage depending on the fuel level within the fuel tank. The fuel cutoff valve comprises: a casing having a casing main body that has a valve chamber communicating with the fuel tank interior and a connection conduit connecting the valve chamber with the outside passage; and a lower cover installed in the lower part of the casing main body and covering the lower opening of the valve chamber; and a float mechanism having a float housed within the valve chamber and moving up and down depending on the fuel level; an upper valve mechanism having a valve element positioned moveably up and down on the upper part of the float for opening and closing the connection conduit, and a connection hole of smaller passage dimensions than the connection conduit, passing through the valve element and connecting the connection conduit to the valve chamber; and a rubber seat member installed in the upper part of the float, for opening and closing the connection hole. The seat member has a seat portion for seating at the edge of the opening of the connection hole; and a valve support element projecting from the lower face of the seat portion in the direction of up and down movement of the float. The valve support element is formed so as to come into contact against the lower cover with the float in the down position.

In another possible configuration for a preferred embodiment of the present invention, the float includes a support hole in the upper part of the float; the valve support element includes a circular cylindrical support base projecting from the lower face of the seat portion and inserting into the support hole, and a stop projection projecting in the diametrical direction from the outside peripheral part of the support base and engaging the edge of the opening of the support hole thereby detaining the seat member on the float; and the lower end of the support base is formed so as to come into contact against the lower cover. With this configuration, the seat member can be attached securely to the float.

In yet another possible configuration for a preferred embodiment of the present invention, the lower cover includes a cover main body of disk shape covering the lower opening of the casing main body; and a bottom support portion projecting upward from the cover main body to contact and support the valve support element. With this configuration, the gap with respect to the seat member is reduced by the equivalent of the projecting height of the bottom support portion, and the valve support element of the rubber seat member can be smaller.

In yet another possible configuration for a preferred embodiment of the present invention, the bottom support portion includes an upper end for supporting a portion of the lower end of the support base in such a way that when contacting and supporting the lower end of the support base, the internal space of the support base will not become hermetically sealed thereby. It is possible thereby to prevent the seat member from sticking to the bottom support portion.

In yet another possible configuration of an embodiment, the float includes a buoyancy chamber that opens downward; and the bottom support portion is formed so as to insert into the buoyancy chamber. With this configuration, the bottom support portion can also provide the function of guiding the wall of the buoyancy chamber of the float, preventing the float from tilting.

In another possible configuration, the bottom support portion has a plurality of legs that insert into the support hole, and engaging claws formed on the legs; with lower ends of the legs being formed so as to contact the lower cover. With this configuration as well, it is possible to prevent the seat member from sticking to the bottom support portion.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a sectional view depicting a fuel cutoff valve pertaining to a first embodiment of the present invention.

FIG. 2 is an exploded sectional view of a first casing unit and a first valve mechanism.

FIG. 3 is an exploded perspective view of the first casing unit and the first valve mechanism.

FIG. 4 is a perspective view of a seat member viewed from below.

FIG. 5 is an enlarged sectional view of the vicinity of the first valve mechanism.

FIG. 6 is an exploded sectional view of a second casing unit and a second valve mechanism.

FIG. 7 is an exploded perspective view of the second valve mechanism.

FIG. 8-10 illustrate operation of the fuel cutoff valve.

FIG. 11 depicts the vicinity of a first valve mechanism pertaining to another embodiment.

FIG. 12 is a sectional view depicting a fuel cutoff valve pertaining to yet another embodiment.

### DESCRIPTION OF THE PREFERRED EMBODIMENTS

### (1) General Configuration of Fuel Cutoff Valve

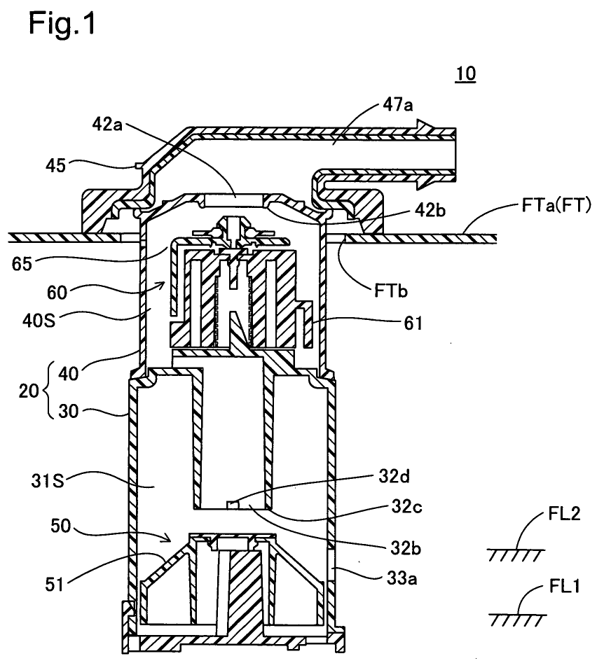

FIG. 1 is a sectional view depicting a fuel cutoff valve 10 pertaining to a first embodiment of the present invention. A fuel tank FT depicted in FIG. 1 is formed of composite resin material that includes polyethylene on the surface, and has a mounting hole FTb formed in the tank upper wall FTa. The fuel cutoff valve 10 is mounted on the tank upper wall FTa with its lower part inserted in the mounting hole FTb. The fuel cutoff valve 10 is designed to regulate outflow to the canister as well as activate the auto-stop function when the fuel in the fuel tank FT has risen to a first level FL1 during fueling, as well as to prevent overfilling when the fuel level exceeds a second level FL2.

### (2) Configuration of Fuel Cutoff Valve 10 Parts

In FIG. 1, the fuel cutoff valve 10 includes as principal components a casing 20, a first valve mechanism 50, and a second valve mechanism 60. The casing 20 includes a first casing unit 30 and a second casing unit 40 fastened to the top of the first casing unit 30; the first valve mechanism 50 is housed within a first valve chamber 31S in the first casing unit 30, and the second valve mechanism 60 is housed within a second valve chamber 40S in the second casing unit 40.

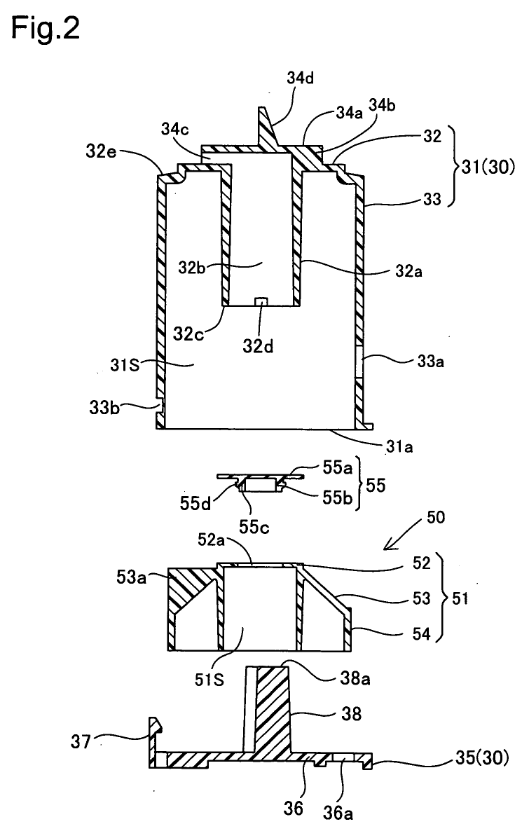

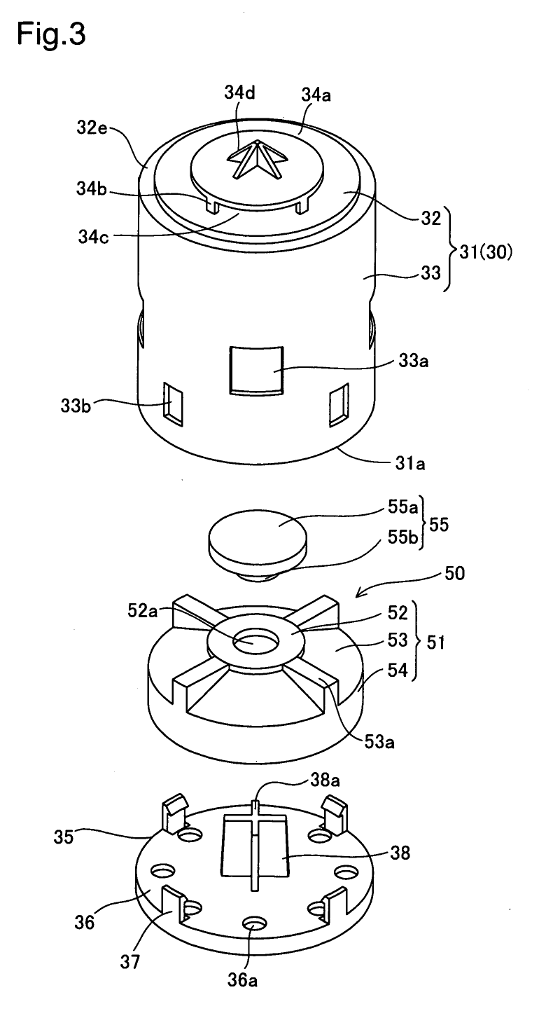

FIG. 2 is an exploded sectional view of the first casing unit 30 and the first valve mechanism 50; and FIG. 3 is an exploded perspective view of the first casing unit 30 and the first valve mechanism 50. The first casing unit 30 includes a casing main body 31 and a lower cover 35 attached to the lower part of the casing main body 31. The casing main body 31 is a cup shape enclosed by a top wall 32 constituting a dividing wall from the second casing unit 40 (FIG. 1), and a side wall 33 formed as a circular cylinder downward from the outside peripheral edge of the top wall 32; its lower end serves as a lower opening 31a. A passage forming element 32a of circular cylindrical shape projects downward from the center part of the top wall 32. A first connection conduit 32b connecting the first valve chamber 31S and the second valve chamber 40S (FIG. 1) is formed within the passage forming element 32a. The edge of the opening of the first connection conduit 32b on the first valve chamber 31S end thereof constitutes a first seal part 32c. Four valve passages 32d produced by cutting away parts of the first seal part 32c are formed in the first seal part 32c at an interval of 90° in the circumferential direction. Four side connection holes 33a are formed in the side wall 33 at an interval of 90° in the circumferential direction. The side connection holes 33a connect the fuel tank FT with the first valve chamber 31S. On the upper face of the top wall 32, an upper wall 34a is supported by legs 34b, forming a communication paths 34c that connect to the first connection conduit 32b. A spring support portion 34d projects from the center top face of the upper wall 34a.

The lower cover 35 is a component for covering the lower opening 31a of the casing main body 31, and includes a cover main body 36 of circular disk shape; engaging claws 37 formed at four locations of the outside peripheral part of the cover main body 36; and a bottom support portion 38 for supporting the first valve mechanism 50. The bottom support portion 38 takes the form of a cross-shaped column extending upward from the center part of the cover main body 36. The engaging claws 37 are claws that engage with engagement grooves 33b of the casing main body 31, thereby attaching the lower cover 35 to the casing main body 31. Connection holes 36a are formed in the casing main body 31 at eight locations along the circumferential direction thereof.

The first valve mechanism 50 is housed within the first valve chamber 31S, and includes a first float 51 and a seat member 55. The first float 51 is a cup shape having a buoyancy chamber 51S that is open at the bottom; and is formed by an upper wall 52, an inclined surfaces 53 formed from the outside peripheral part of the upper wall 52, and a side wall 54 projected with circular cylindrical shape from the outside peripheral part of the inclined surfaces 53. The upper wall 52 has a support hole 52a for mounting the seat member 55. The inclined surfaces 53 are positioned so as to be facing the side connection holes 33a, and passages connecting to the first connection conduit 32b are formed through the space thereabove (see FIG. 1). Guide ribs 53a are formed between the inclined surfaces 53.

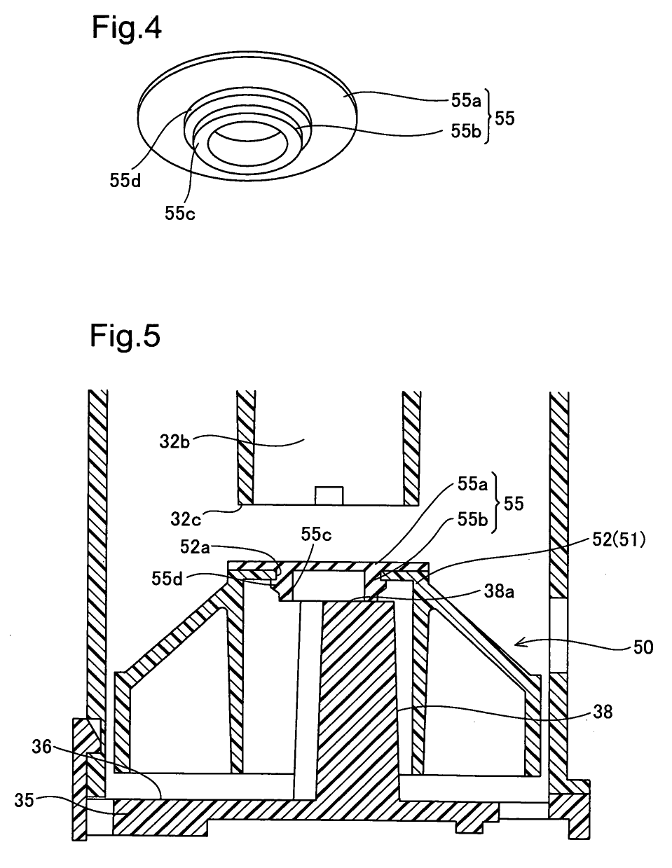

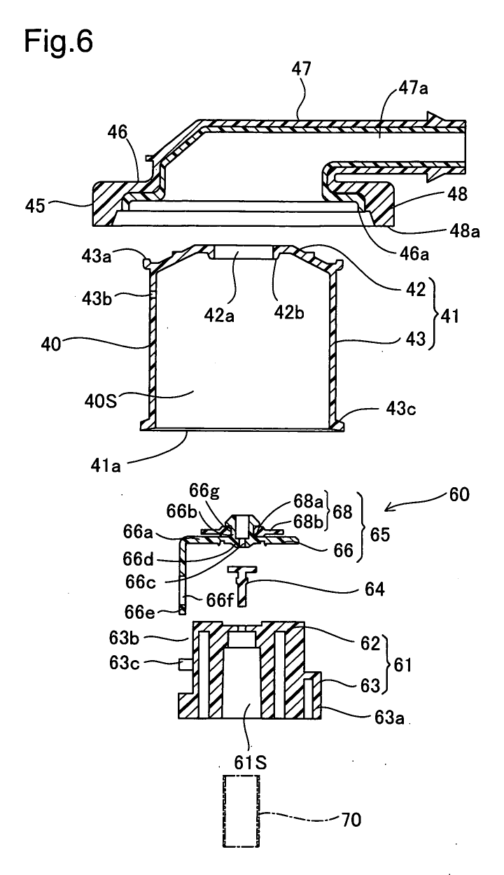

FIG. 4 is a perspective view of the seat member 55 viewed from below; and FIG. 5 is an enlarged sectional view of the vicinity of the first valve mechanism 50. The seat member 55 is a valve made of rubber which is installed on the upper part of the first float 51 and which seats in the first seal part 32c thereby closing the first connection conduit 32b; it includes a seat portion 55a of circular disk shape, and a valve support element 55b projected in circular cylinder shape from the lower face of the seat portion 55a. The valve support element 55b includes a support base 55c of circular cylinder shape projecting from the lower face of the seat portion 55a and inserting into the support hole 52a; and a stop projection 55d projecting in the diametrical direction from the outside peripheral part of the support base 55c and engaging the edge of the opening of the support hole 52a thereby detaining the seat member 55 on the float. The seat member 55 is installed on the first float 51 by press-fitting the valve support element 55b into the support hole 52a. By so doing, the seat member 55 is installed on the first float 51 with the stop projection 55d detained through engagement with the edge of the opening of the support hole 52a.

As shown in FIG. 5, when the first float 51 is in the down position, the valve support element 55b of the seat member 55 will come into contact against the upper end 38a of the bottom support portion 38 of the lower cover 35; whereas when the first float 51 is in the up position it will move away from the upper end 38a of the bottom support portion 38. Specifically, with the first float 51 in the down position with its lower end away from the cover main body 36 of the lower cover 35, the valve support element 55b of the seat member 55 will come into contact against the bottom support portion 38 and be supported on the lower cover 35. Thus, when the first float 51 vibrates slightly, the valve support element 55b of the rubber seat member 55 will come into contact against the bottom support portion 38, reducing the impact energy at this time. Moreover, since the bottom support portion 38 is formed with a cross-shaped horizontal cross section, passages will form in the space to the inside of the circular cylindrical valve support element 55b, and since these internal spaces do not become hermetically sealed, there will be no increase in resistance when the seat member 55 separates from the bottom support portion 38.

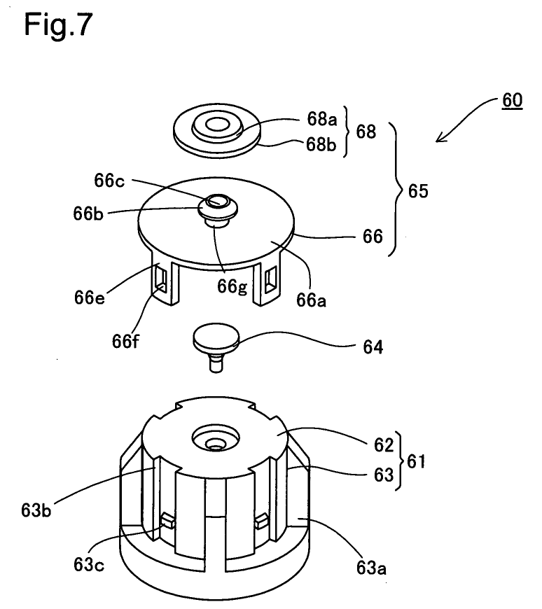

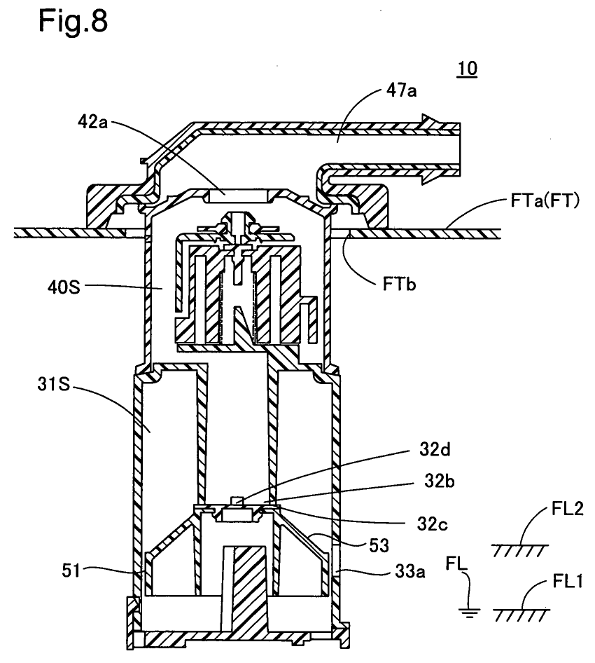

FIG. 6 is an exploded sectional view of the second casing unit 40 and the second valve mechanism 60; and FIG. 7 is an exploded perspective view of the second valve mechanism 60. The second casing unit 40 includes a casing main body 41, and a cover 45 attached to the upper part of the casing main body 41. The casing main body 41 is a cup shape enclosed by an upper wall 42 and a side wall 43 of circular cylinder shape, with its bottom end constituting a lower opening 41a. A second connection conduit 42a is formed in the upper wall 42, with the edge of its opening constituting a second seal part 42b. A flange 43c juts towards the outside peripheral direction at the lower edge of the side wall 43. The flange 43c is unified with the first casing unit 30 by welding it to the upper step 32e of the first casing unit 30 shown in FIG. 2. A vent 43b is formed in the upper part of the side wall 43. The vent 43b is an air inlet provided for expelling fuel that has collected in the second valve chamber 40S.

The cover 45 includes a cover main body 46, a tubular body 47 that projects towards the side from the center of the cover main body 46, and a flange 48 formed on the outside periphery of the cover main body 46; these elements are integrally formed. A cover passage 47a is formed in the tubular body 47; one end of the cover passage 47a is connected through the second connection conduit 42a to the second valve chamber 40S of the casing main body 41, while the other end is connected to the canister (not shown). An inner welded edge 46a for welding to the flange 43a at the upper outside peripheral part of the casing main body 41 is formed on the lower part of the cover main body 46; and an outer welded edge 48a for welding to the tank upper wall FTa of the fuel tank FT is formed on the lower edge of the flange 48.

The second valve mechanism 60 is housed within the second valve chamber 40S, and includes a second float 61, a valve body 64, and upper valve mechanism 65, and a spring 70. The second float 61 is a cup shape having a buoyancy chamber 61S that is open at the bottom; and includes an upper wall 62, and a side wall 63 projected with circular cylindrical shape from the outside peripheral part of the upper wall 62. The rubber valve body 64 is attached to the center part of the upper wall 62. Guide projections 63a extending in the vertical direction are formed on the side wall 63 at four equidistant intervals in the circumferential direction. The guide projections 63a slide along the inside wall of the side wall 43 of the second casing unit 40 thereby guiding the second float 61 so as to prevent it from tilting when moving up and down. The second float 61 is supported by the spring 70 which extends between the lower face of the upper wall 62 and the upper wall 34a of the first casing unit 30 (FIG. 3). The spring 70 is positioned by the spring support portion 34d on the upper wall 34a.

The upper valve mechanism 65 is a valve for improving valve reopening characteristics; it is supported moveably up and down on the upper part of the second float 61, and includes a valve support member 66 and a rubber valve body 68 installed on the valve support member 66. The valve support member 66 has a support upper plate 66a of circular disk shape; a valve passage projection 66b projects upward from its center, with a connecting hole 66c passing through the valve passage projection 66b. A lower seal portion 66d is formed on the edge of the lower opening of the connecting hole 66c wherein the valve body 64 of the second float 61 alternately seats and unseats. Four support arms 66e that slide through guide grooves 63b project downward on the diagonal at intervals of 90° from the outside peripheral part of the support upper plate 66a. Guide slots 66f are formed in the support arms 66e, and by inserting therein stop projections 63c provided to the second float 61, the upper valve mechanism 65 is supported moveably up and down by a prescribed distance with respect to the second float 61.

A valve support recess 66g is formed on the outside peripheral part of the valve passage projection 66b in the upper part of the valve support member 66. The rubber valve body 68 is supported on the valve support member 66 by press-fitting a support base 68a provided to the rubber valve body 68 into the valve support recess 66g. The rubber valve body 68 has a seat portion 68b in the outside peripheral part of the support base 68a; the second connection conduit 42a opens and closes through alternate seating and unseating of the seat portion 68b with respect to the second seal part 42b.

### (3) Fuel Cutoff Valve Operation

The operation of the fuel cutoff valve 10 will be described as follows. In FIG. 1, when fuel is supplied to the fuel tank FT by fueling, fuel vapors which have collected in the upper part of the fuel tank FT as the fuel level within the fuel tank FT rises will escape from the fuel cutoff valve 10 and into the canister through a conduit (not shown). Specifically, during the interval prior to the fuel level in the fuel tank FT reaching the first level FL1, the first float 51 and the second float 61 are unseated from the first seal part 32c and the second seal part 42b respectively situated in the first valve chamber 31S and the second valve chamber 40S, and thus the fuel vapors will be enter the second valve chamber 40S via the first valve chamber 31S and the first connection conduit 32b, then flow from the second valve chamber 40S into the canister via the second connection conduit 42a and the cover passage 47a.

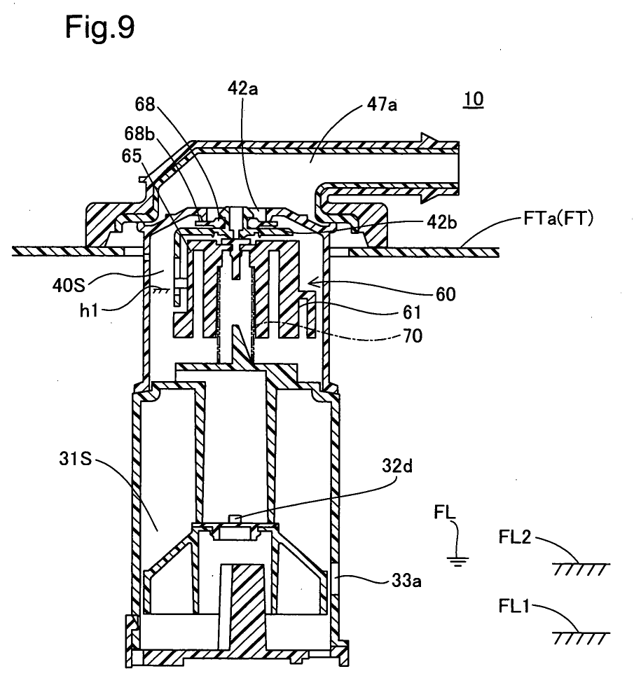

As shown in FIG. 8, as the fuel level FL in the fuel tank FT rises further and reaches the first level FL1, fuel will flow into the first valve chamber 31S. Once the buoyancy of the first float 51 overcomes gravity, it will rise quickly and become seated in the first seal part 32c, closing off the first connection conduit 32b. In this condition, the valve passage 32d formed in the first seal portion 32c maintains ventilation with the first connection conduit 32b in a state of constricted passage dimensions so that the fuel vapors inside the fuel tank FT will escape from the side connection hole 33a, through the passage above the inclined surfaces 53 of the first float 51, and then into the canister through the valve passage 32d, the second valve chamber 40S, the second connection conduit 42a, and the cover passage 47a. At this time, tank internal pressure within the fuel tank FT will rise due to constriction by the valve passage 32d which constitutes the constricted portion. Due to this rise in tank internal pressure the fluid level in the inlet pipe will rise, tripping the auto-stop function which halts fueling by the fuel gun. However, the passages such as the valve passage 32d connect with the canister and function to avoid a sudden rise in tank pressure, thus preventing associated splashback of fuel.

Furthermore, as shown in FIG. 9, when the fuel level FL reaches the second level FL2, the side connection hole 33a is blocked off. In this condition, inflow of fuel vapors to the second valve chamber 40S through the valve passage 32d will be cut off. The valve chamber 40S connects to the canister via the second connection conduit 42a and the cover passage 47a, and its internal pressure is substantially equal to atmospheric pressure. Since the tank internal pressure of the fuel tank FT is higher than atmospheric pressure, fuel will inflow rapidly through the first valve chamber 31S and the valve passage 32d and into the second valve chamber 40S due to the pressure differential. Then, when the fuel level within the second valve chamber 40S reaches a height hi, where the balance between upward force produced by the buoyancy of the second float 61 and the load of the spring 70 vis-à-vis downward force produced by the weight of the second valve mechanism 60 including the second float 61 and the upper valve mechanism 65 is such that the former now overcomes the latter, the second valve mechanism 60 will rise and the seat portion 68b of the rubber valve body 68 will seat in the second seal part 42b, closing off the second connection conduit 42a. Thus, the passage connecting to the canister will close off, and since the fuel tank FT interior is hermetically closed with respect to the canister side, overfill by the fuel gun can be prevented.

Furthermore, as shown in FIG. 10, as the fuel in the fuel tank FT is consumed and the fuel level FL drops, the second float 61 decreases in buoyancy and descends slightly. Due to descent of the second float 61, the valve body 64 of the second float 61 will unseat from the lower seal portion 66d, opening up the connecting hole 66c. Due to the open passage through the connecting hole 66c the pressure level above the upper valve mechanism 65 will then reach the same level as the pressure in the vicinity of the second connection conduit 42a. Then, as a result of the descent of the upper valve mechanism 65, the seat portion 68b of the rubber valve body 68 will unseat from the second seal part 42b, the second connection conduit 42a will open, and pressure inside the fuel tank FT will be released to the canister side. Thus, by setting the passage dimensions of the connecting hole 66c smaller than the passage dimensions of the second connection conduit 42a, the upper valve mechanism 65 will open at lower force from the second seal part 42b. This two-stage valve structure involving the rubber valve body 68 of the upper valve mechanism 65 and the valve body 64 of second float 61 functions so as to promote improved valve reopening characteristics.

### (4) Working Effects of the Embodiment

The constitution of the embodiment described above affords the following working effects.

(4)-1 The seat member 55 is installed in the upper part of the upper wall 52 of the first float 51, and the valve support element 55b extends downward. By coming into contact against the upper end 38a of the bottom support portion 38, the valve support element 55b will absorb energy associated with vibration of the first float 51, reducing impact noise of the first float 51 and the lower cover 35. Since the valve support element 55b extends downward from the seat portion 55a, absorption of energy produced by vibration of the first float 51 can be increased, and excellent noise reducing effect achieved, with no increase in the number of parts.

(4)-2 By inserting the seat member 55 into the support hole 52a of the first float 51 and engaging the stop projection 55d of the valve support element 55b with the peripheral edge of the support hole 52a, the seat member 55 may be attached to the first float 51 in a simple manner and with no mispositioning with respect to the first float 51.

(4)-3 Since the seat member 55 is a separate component from the first float 51, it is possible to select for it a material and shape that are optimal in terms of vibration absorption of the first float 51; and since the it attaches easily to the first float 51 of fuel cutoff valves of various types, it is highly adaptable.

(4)-4 The bottom support portion 38 of the lower cover 35 can reduce, by the equivalent of its projecting height, the size of the gap with respect to the seat member 55, and the valve support element 55b of the rubber seat member 55 can be smaller. Also, the bottom support portion 38 is formed so as to insert into the buoyancy chamber 51S of the first float 51, and thus can also function to guide the wall surface of the buoyancy chamber 51S, preventing the first float 51 from tilting.

(4)-5 The upper end 38a of the bottom support portion 38 is formed with a cross shape that supports a portion of the lower end of the support base 55c in such a way that when it contacts and supports the lower end of the support base 55c of the seat member 55 the internal space of the support base 55c will not become hermetically sealed thereby; thus, the seat member 55 can be prevented from sticking to the bottom support portion 38.

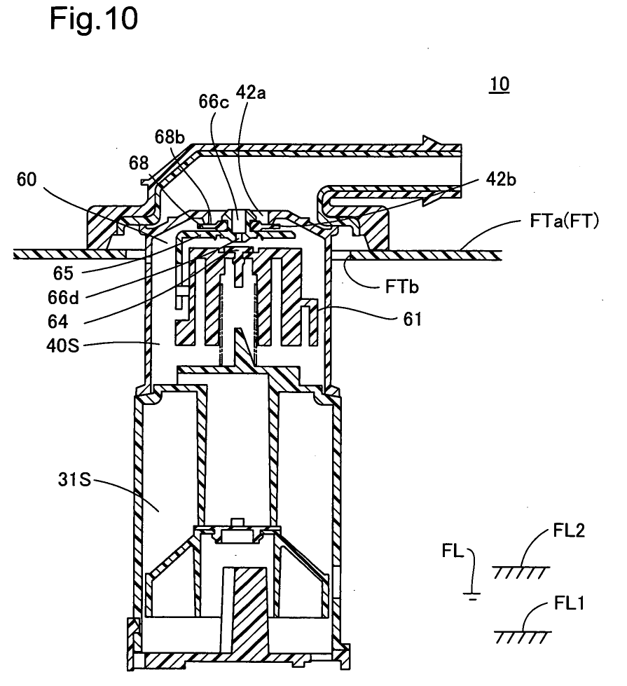

FIG. 11 shows the vicinity of a first valve mechanism 50B pertaining to another embodiment. A feature of the present embodiment is the shape of the seat member 55B. The seat member 55B has a seat portion 55Ba shown by broken lines, and a valve support element 55Bb projected from the lower face of the seat portion 55Ba. The valve support element 55Bb has a plurality of legs 55Bc that insert into a support hole 52Ba of the first float 51B, and engaging claws 55Bd formed in the lower part of the legs 55Bc; the lower ends of the legs 55Bc are formed so as to come into contact against the lower cover 35B. When the valve support element 55Bb is inserted into the support hole 52Ba, the engaging claws 55Bd engage the edge of the opening of the support hole 52Ba thereby attaching the seat member 55B to the first float 51B. In the present embodiment, impact noise against the first float 51B can be reduced by the valve support element 55Bb coming into contact against the upper end of the bottom support portion 38B. Also, since the valve support element 55Bb is formed from multiple legs 55Bc, a hermetic chamber will not form between the seat member 55B and the upper end 38Ba of the bottom support portion 38B.

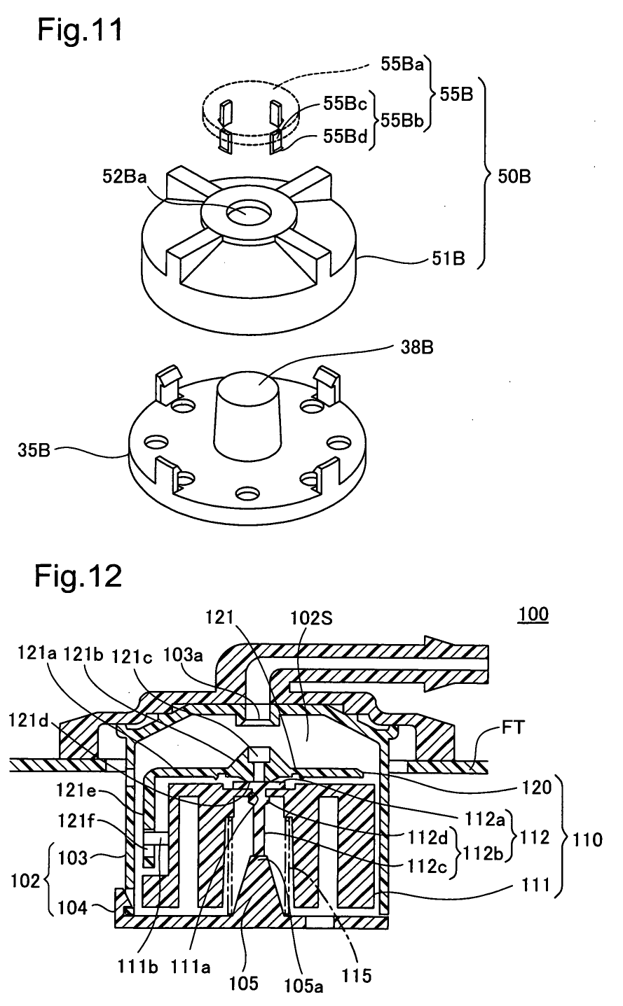

FIG. 12 is a sectional view depicting a fuel cutoff valve 100 pertaining to yet another embodiment. The present embodiment features a configuration adapted for implementation in a rollover valve that prevents fuel from spilling to the outside if the vehicle rocks or tilts, and in which a float mechanism 110 is provided with an upper valve mechanism 120. The fuel cutoff valve 100 includes a casing 102, the float mechanism 110 which is housed within a valve chamber 102S inside the casing 102 and a spring 115 for urging the float mechanism 110. The casing 102 includes a casing main body 103 having a connection conduit 103a in its upper part; and a lower cover 104 installed on the lower part of the casing main body 103. The lower cover 104 includes a cover main body 104a and a bottom support portion 105 projects from the top center of the cover main body 104a. The float mechanism 110 includes a float 111; a rubber seat member 112 installed in a support hole 111a of the float 111; and the upper valve mechanism 120 which rests on the upper face of the seat member 112. The seat member 112 includes a seat portion 112a; and a rod-shaped valve support element 112b projected downward from the lower face of the seat portion 112a. The valve support element 112b includes a rod-shaped support base 112c projected downward from the lower face of the seat portion 112a; and a stop projection 112d projected in the diametrical direction from the outside peripheral part of the support base. The lower end of the support base 112c rests against the upper end 105a of the bottom support portion 105.

The upper valve mechanism 120 has a configuration and operation substantially the same as the second valve mechanism 60 of FIG. 1, and affords excellent valve reopening characteristics; it includes an upper valve main body 121. The upper valve main body 121 includes a support upper plate 121a of circular disk shape; a valve element 121b projected in conical shape from the center part of the upper plate 121a; a connection hole 121c passing through the valve element 121b and having smaller passage dimensions than the connection conduit 103a; a lower seal portion 121d provided at the edge of the lower opening of the connection hole 121c; and four support arms 121e projected downward from the outside peripheral part of the support upper plate 121a. A guide slot 121f guided by a stop projection 111b of the float 111 is formed in the support arm 121e. With this configuration of the upper valve mechanism 120, when the float 111 and the seat member 112 descend, the connection hole 121c of the upper valve mechanism 120 will open first, and then the connection conduit 103a will open through descent of the upper valve mechanism 120.

If rocking of the vehicle or the like should cause the fuel level in the fuel tank FT to surge and produce vibration in the vertical direction in the float 111, before the lower end of the float 111 comes in contact against the lower cover 104, the valve support element 112b of the rubber seat member 112 will come into contact against the upper end 105a of the bottom support portion 105, reducing impact noise associated with vibration of the float mechanism 110.

The invention should not be construed as limited to the preferred embodiments hereinabove, and may be reduced to practice in various ways without departing from the spirit thereof, such as the following modifications for example.

For example, in the present invention, the mechanism for absorbing impact when the rubber seat member seats and unseats from the bottom support is not limited in any particular way provided it is capable of fulfilling this function; the seat member and bottom support portion 105 in the embodiment of FIG. 12 could be replaced with the configuration shown in FIG. 1 or 11 implemented appropriately; or the embodiment of FIG. 12 could be implemented in the embodiment of FIG. 1 for example.

The foregoing detailed description of the invention has been provided for the purpose of explaining the principles of the invention and its practical application, thereby enabling others skilled in the art to understand the invention for various embodiments and with various modifications as are suited to the particular use contemplated. The foregoing detailed description is not intended to be exhaustive or to limit the invention to the precise embodiments disclosed. Modifications and equivalents will be apparent to practitioners skilled in this art and are encompassed within the spirit and scope of the appended claims.

What is claimed is:

1. A fuel cutoff valve that is attached to an upper part of a fuel tank, and works by a fuel level in the fuel tank, the fuel cutoff valve comprising:
a casing having (i) a casing main body that has a valve chamber communicated with the fuel tank interior and a connection conduit connecting the valve chamber with an outside passage, and (ii) a lower cover attached to a lower part of the casing main body and covering a lower opening of the valve chamber; and
a float mechanism having (i) a float housed within the valve chamber and moving up and down between an up position and a down position depending on the fuel level, and (ii) a rubber seat member installed in an upper part of the float for opening and closing the connection conduit,
wherein the seat member has (i) a seat portion for opening and closing the connection conduit, and (ii) a valve support element projecting from a lower part of the seat portion in the direction of up and down movement of the float, and
the valve support element is configured to be supported on the lower cover by being placed on an upper portion of the lower cover at the down position of the float.

2. The fuel cutoff valve in accordance with claim 1, wherein
the float includes a support hole in the upper part of the float, and
the valve support element includes (i) a support base projecting from a lower face of the seat portion and inserting into the support hole, and (ii) a stop projection projecting in a diametrical direction from an outside peripheral part of the support base and engaging with an edge of an opening of the support hole, thereby detaining the seat member on the float, wherein a lower end of the support base is configured to be placed on the lower cover.

3. The fuel cutoff valve in accordance with claim 1, wherein
the lower cover includes (i) a disc-shaped cover main body covering the lower opening of the casing main body, and (ii) a bottom support portion projecting upward from the cover main body to support the valve support element.

4. The fuel cutoff valve in accordance with claim 3, wherein
the valve support element is a cylindrical shape, and
the bottom support portion includes an upper end for supporting the lower end of the support base, the upper end of the bottom support portion being configured such that an internal space within the cylindrical support base does not become hermetically sealed when the lower end of the support base is placed on the upper end of the bottom support portion.

5. The fuel cutoff valve in accordance with claim 4, wherein
the float includes a buoyancy chamber that opens downward, and the valve support element is configured to insert into the buoyancy chamber.

6. The fuel cutoff valve in accordance with claim 1, wherein
the float includes a support hole in the upper part of the float, and
the valve support element has a plurality of legs that insert into the support hole, and engaging claws formed on the legs, lower ends of the legs being configured to be placed on the lower cover.

7. A fuel cutoff valve that is attached to an upper part of a fuel tank, and works by a fuel level in the fuel tank, the fuel cutoff valve comprising:
a casing having (i) a casing main body that has a valve chamber communicating with the fuel tank interior and a connection conduit connecting the valve chamber with the outside passage; and (ii) a lower cover attached to a lower part of the casing main body and covering a lower opening of the valve chamber; and
a float mechanism having (i) a float housed within the valve chamber and moving up and down between an up position and a down position depending on the fuel level, (ii) a rubber seat member attached to the upper part of the float, and (iii) an upper valve mechanism positioned moveably up and down above the upper part of the float,
wherein the upper valve mechanism includes (i) a valve element for opening and closing the connection conduit, (ii) a connection hole of smaller passage dimensions than the connection conduit, passing through the valve element and connecting the connection conduit to the valve chamber,
the seat member has (i) a seat portion for opening and closing the connection hole, and (ii) a valve support element projecting from a lower face of the seat portion in the direction of up and down movement of the float, and
the valve support element is configured to be supported on the lower cover by being placed on an upper portion of the lower cover at the down position of the float.

8. The fuel cutoff valve in accordance with claim 7, wherein
the float includes a support hole in the upper part of the float, and
the valve support element includes (i) a support base projecting from a lower face of the seat portion and inserting into the support hole, and (ii) a stop projection projecting in a diametrical direction from an outside peripheral part of the support base and engaging with an edge of an opening of the support hole thereby detaining the seat member on the float, wherein a lower end of the support base is configured to be placed on the lower cover.

9. The fuel cutoff valve in accordance with claim 8, wherein
the support base is a rod-shape, and
the lower cover includes (i) a disc-shaped cover main body covering the lower opening of the casing main body, and (ii) a bottom support portion projecting upward from the cover main body to support the support base.

10. The fuel cutoff valve in accordance with claim 9, wherein
the float includes a buoyancy chamber that opens downward, and the valve support element is configured to insert into the buoyancy chamber.
